(19) United States
(12) Patent Application Publication
(10) Pub. No.: US 2025/0133200 A1
(43) Pub. Date: Apr. 24, 2025

(54) IMAGE COMPRESSION USING A VARIATIONAL AUTOENCODER

(71) Applicant: Microsoft Technology Licensing, LLC, Redmond, WA (US)

(72) Inventor: Shudong ZHU, Issaquah, WA (US)

(21) Appl. No.: 18/489,833

(22) Filed: Oct. 18, 2023

(51) Int. Cl. H04N 19/103; G06F 16/532; H04N 19/136

(52) U.S. Cl. CPC H04N 19/103; G06F 16/532; H04N 19/136

(57) ABSTRACT

Disclosed solutions perform image compression using a variational autoencoder that enables greater compression than traditional methods, while simultaneously maintaining superior fidelity for the decompressed image. Examples persist the bottleneck layer output of a variational autoencoder as a compressed image in the form of a latent tensor. The latent tensor is decompressed by a variational autodecoder into a recovered image in pixel space. In some examples, different encoder/decoder pairs are trained on specific image types, based on feature attributes. For example, maps have lines that are narrow compared to their length (e.g., have a high aspect ratio) which are different than features within photographs of people and scenes. Some examples leverage contrastive language-image pre-training (CLIP) and/or bootstrapping language-image pre-training (BLIP) models to store embeddings, each associated with a compressed image, to enable natural language searches of compressed image collections without requiring decompression.

### BACKGROUND

Traditional image compression solutions use one or multiple compression algorithms such as Fourier transform (FT), principal component analysis (PCA) dimension deduction, fractal compression based on chaotic theory, and others. However, these solutions are notably lossy (e.g., blurring images and losing information) when achieving high compression ratios.

FT-based solutions compresses images by discarding high frequency information, which may be deemed to be of lesser significance, but blurs edges between pixels of different colors. PCA-based solutions compresses images by reducing feature dimensions, which discards image features. Fractal compression compresses images by determining a fractal function that simulates image data upon reconstruction, resulting in differences between what may have actually been in the image, and what is reconstructed by the simulation.

### SUMMARY

The disclosed examples are described in detail below with reference to the accompanying drawing figures listed below. The following summary is provided to illustrate some examples disclosed herein.

Example solutions perform image compression using a variational autoencoder. Examples receive a first image of a first image type for compression, the first image in pixel space; provide the first image to a first variational autoencoder, the first variational autoencoder having a bottleneck layer; persist an output of the bottleneck layer of the first variational autoencoder as a first compressed image, the first compressed image comprising a latent tensor; and based on at least receiving a request to decompress the first compressed image, decompress, by a first variational autodecoder, the first compressed image into a first recovered image, the first recovered image in pixel space.

### BRIEF DESCRIPTION OF THE DRAWINGS

The disclosed examples are described in detail below with reference to the accompanying drawing figures listed below:

FIG. 1 illustrates an example architecture that advantageously performs image compression using a variational autoencoder;

FIG. 2 illustrates further detail for compression with a variational autoencoder and decompression with a variational autodecoder, as may be used in example architectures such as that of FIG. 1;

FIG. 3 illustrates how the compression and decompression used in example architectures, such as that of FIG. 1, may be tailored to different image types;

FIG. 4 illustrates further detail for training variational autoencoders and variational autodecoders used in example architectures, such as that of FIG. 1;

FIG. 5 illustrates searching for compressed images without requiring decompression, as may be performed in example architectures such as that of FIG. 1;

FIG. 6 is flowchart illustrating exemplary operations that may be performed in example architectures such as that of FIG. 1;

FIGS. 7A, 7B, 7C, and 7D are flowcharts showing further detail for various operations of the flowchart of FIG. 6;

FIG. 8 is another flowchart illustrating exemplary operations that may be performed in example architectures such as that of FIG. 1; and

FIG. 9 shows a block diagram of an example computing device suitable for implementing some of the various examples disclosed herein.

Corresponding reference characters indicate corresponding parts throughout the drawings. Any of the figures may be combined into a single example or embodiment.

### DETAILED DESCRIPTION

Disclosed solutions perform image compression using a variational autoencoder that enables greater compression than traditional methods, while simultaneously maintaining superior fidelity for the decompressed image. Examples persist the bottleneck layer output of a variational autoencoder as a compressed image in the form of a latent tensor. The latent tensor is decompressed by a variational autodecoder into a recovered image in pixel space. In some examples, different encoder/decoder pairs are trained on specific image types, based on feature attributes. For example, maps have lines that are narrow compared to their length (e.g., have a high aspect ratio) which are different than features within photographs of people and scenes. Some examples leverage contrastive language-image pre-training (CLIP) and/or bootstrapping language-image pre-training (BLIP) models to store embeddings, each associated with a compressed image, to enable natural language searches of compressed image collections without requiring decompression.

Aspects of the disclosure provide new techniques for performing image compression, including the particular process for training encoders/decoders to handle different image types that achieve superior performance over traditional image compression approaches, and also details for creating and employing a searchable dataset for rapidly locating compressed images satisfying natural language searches. Examples include persisting an output of a bottleneck layer of a variational autoencoder as a compressed image; training variational autoencoders/autodecoders to compress/decompress images by image type (e.g., differentiated by identifiable features within each image type, such as feature aspect ratios); and associating a CLIP and/or BLIP embedding with a compressed image. Aspects of the disclosure solve multiple problems that are necessarily rooted in computer technology, such as high compression of digital images (saving significant storage space) and technically efficient searching (e.g., in terms of processing and memory usage) collections of highly-compressed digital images without requiring computationally expensive decompression.

The various examples are described in detail with reference to the accompanying drawings. Wherever preferable, the same reference numbers are used throughout the drawings to refer to the same or like parts. References made throughout this disclosure relating to specific examples and implementations are provided solely for illustrative purposes but, unless indicated to the contrary, are not meant to limit all examples.

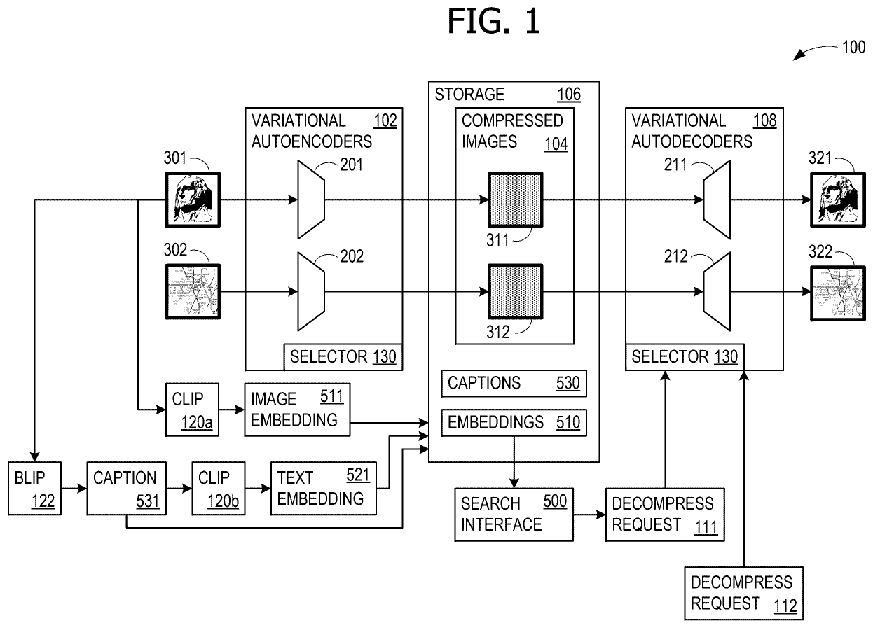

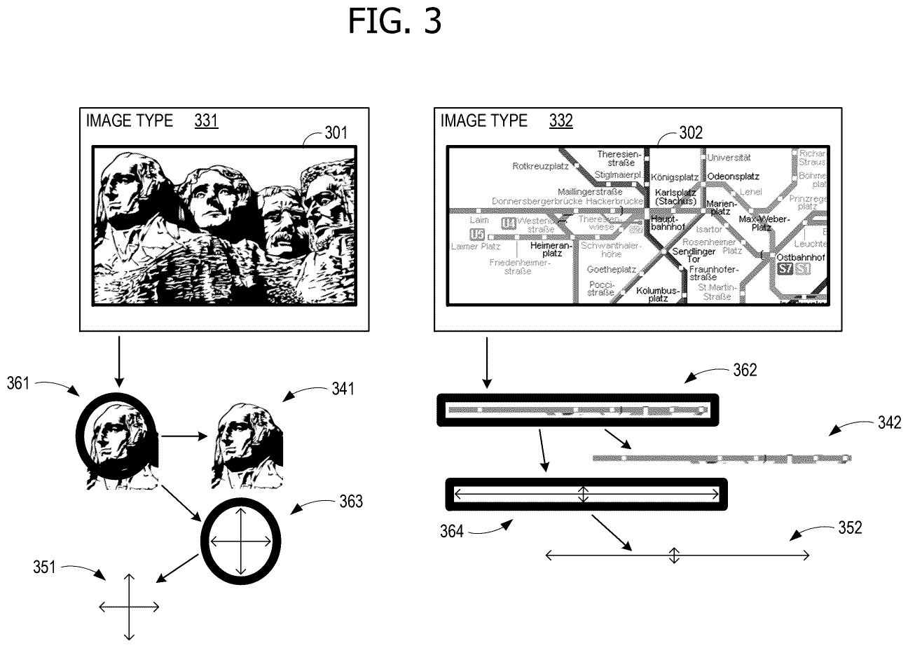

FIG. 1 illustrates an example architecture 100 that advantageously performs image compression using a variational autoencoder 201 to compress an image 301 into a compressed image 311. In some examples, different variational autoencoders within a plurality of variational autoencoders 102 are used to compress images of different types, such as using a variational autoencoder 202 to compress an image 302 into a compressed image 312, when image 302 is a different type of image than image 301. What defines images as different types, for the purposes of selecting which variational autoencoder within plurality of variational autoencoders 102 to use for compression, is described below in relation to FIG. 3. A selector 130 selects from among the available variational autoencoders (e.g., variational autoencoders 201 and 202) for compression, based on image type. Some examples may, however, use just a single variational autoencoder for all image types.

Compressed images 311 and 312 are persisted (e.g., stored) within plurality of compressed images 104 in storage 106. Upon receiving a request for decompression, such as a request 111 to decompress compressed image 311 or a request 112 to decompress compressed image 312, the identified compressed image is decompressed using a variational autodecoder within a plurality of variational autodecoders 108 that corresponds to the variational autoencoder used to compress the compressed image. For example, a variational autodecoder 211, which corresponds to variational autoencoder 201, is used to decompress compressed image 311 into recovered image 321, and a variational autodecoder 212, which corresponds to variational autoencoder 202, is used to decompress compressed image 312 into recovered image 322. Selector 130 also selects from among the available variational autodecoders (e.g., variational autodecoders 211 and 212) for decompression (e.g., restoration), based on which variational autoencoder was used for compression. Some examples may, however, use just a single variational autodecoder for all image types.

The compression ratios provided by architecture 100 are relatively high, given the fidelity that is maintained in the decompressed images. For example, a 512×512 color image in pixel space (e.g., the domain of images 301 and 302 and recovered images 321 and 322) is a 3×512×512 tensor—a 3-layer 512×512 pixel matrix, with one layer for each color red, green, blue in RGB space or another color space (e.g., YCbCr). The corresponding compressed image, using architecture 100 is a 4×64×64 tensor in latent space (e.g., the domain of compressed images 311 and 312).

Using examples of architecture 100, a 401 kilobytes (KB) image compresses to 33 KB, which is a 12:1 compression ratio, and takes up only 8.2% as much storage space as the uncompressed image. This high compression rate is achieved with a mean-squared error (MSE) of only 11.5. MSE is calculated using:

$$M S E = \frac{{\sum }_{i = 0}^{W - 1} {{\sum }_{j = 0}^{H - 1} [ X ( i , j ) - Y ( i , j ) ]}^{2}}{W \times H} \qquad Eq . ( 1 )$$

where W is the width, H is the height, X is a pixel value in the original image (e.g., image 301), and Y is the corresponding pixel value in the recovered original image (e.g., recovered image 321). A lower MSE indicates higher fidelity in the recovered image.

The compression ratio varies as a function of image size, in some examples, such as a 548 KB image compresses to 60 KB, which is a nearly 10:1 compression ratio, with an MSE of only 8.2, and a 6,671 KB image compresses to 939 KB, which is a 7:1 compression ratio, with an MSE of only 2.8. These MSE values use [0 to 255] value pixels, although pixel value conversion may be needed in some examples. In some examples, each of the [0 to 255] pixel values in RGB color space are converted to a [−1 to +1] value range for input to a variational autoencoder and after output from a variational autodecoder are converted from a [−1 to +1] value range back to the common [0 to 255] pixel value range for display or other output.

Additional pre-processing may be needed to convert the tensor of the original image to a NumPy array, which is a grid of values that are all of the same type, indexed by a tuple of nonnegative integers. The number of dimensions is the rank of the array, and the shape of the array is a tuple of integers giving the size of the array along each dimension. Post-processing may then be needed to convert back to common image formats.

In some scenarios, there may be a need to search through plurality of compressed images 104 for an image satisfying some search criteria, such as by using a natural language (NL) textual description. An example search query may be “An image of a cat chasing a bird.” In examples having a large number of compressed images within plurality of compressed images 104, decompressing each compressed image for the search is computationally expensive. However, in architecture 100, compressed images are in latent space, which is indistinguishable from noise to humans and many automated search processes.

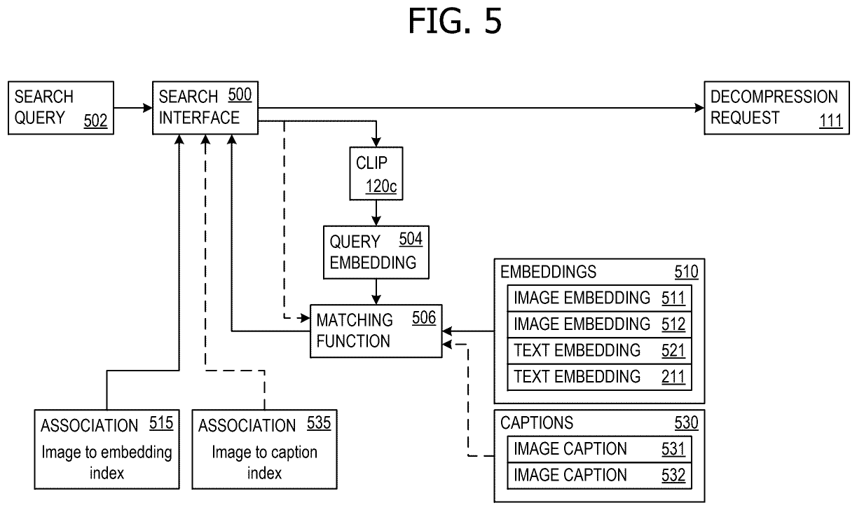

To enable rapid search, a plurality of embeddings 510 is saved in storage 106, which contains image embeddings and/or text embeddings indexed to compressed images 311 and 312 in plurality of compressed images 104. Storage 106 represents a storage capability in general, and may include distributed and/or virtual storage. A search interface 500 receives search criteria and searches plurality of embeddings 510 for the best match (or matches) to the search criteria. As illustrated, search interface 500 has located the best match as compressed image 311 and so generates a request 111 to decompress compressed image 311. This is shown and described in further detail below, in relation to FIG. 5.

To generate the entries in plurality of embeddings 510 that correspond to compressed image 311 (or image 301), image 301 is provided to a CLIP model 120a. CLIP model 120a generates image embedding 511 that is added to plurality of embeddings 510 and persisted in storage 106. In some examples, image 301 is also provided to a BLIP model 122, which generates image caption 531 based on a guided prompt such as “describe the content of the image.” A CLIP model 120b generates text embedding 521 from image caption 531, and text embedding 521 is also added to plurality of embeddings 510 and persisted in storage 106. In some examples, a single CLIP model is used as both CLIP models 120a and 120b, whereas in some examples, different CLIP models are used.

CLIP models 120a and 120b and BLIP model 122 are transformer based image-to text-models. BLIP model 122 generates captions of 4 to 8 words that describe an image. CLIP model 120a (and CLIP model 120b, if a different model) produces shorter text descriptions. For example, for an image of a cat chasing a bird, BLIP model 122 may output “a cat is walking on the grass and a bird is flying in the air”, whereas CLIP model 120a may output “a cat chasing a bird”. In some examples, BLIP model 122 comprises a bootstrapping language-image pre-training for unified vision-language understanding and generation model. Some examples also persist image caption 531 in a plurality of captions 530, and search interface 500 also uses plurality of captions 530 to locate a match for search criteria. Embeddings and a caption for compressed image 312 (or image 302), and other compressed images within plurality of compressed images 104, may be generated similarly.

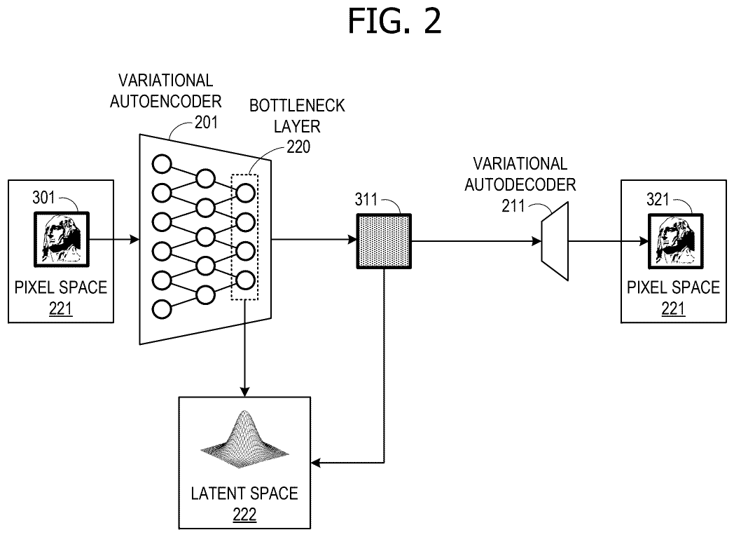

FIG. 2 illustrates further detail for compression with variational autoencoder 201 and decompression with variational autodecoder 211. Compression and decompression with variational autoencoder 202 and variational autodecoder 212 is similar. Image 301 and recovered image 321 are in a pixel space 221, using a 3×W×H tensor and RGB, YCbCr color space. Variational autoencoder 201 has a bottleneck layer 220 from which compressed image 311 is extracted as a latent vector in a latent space 222.

A variational autoencoder is an artificial neural network architecture sometimes abbreviated as VAE. The bottleneck layer (e.g., bottleneck layer 220 of variational autodecoder 211) provides a statistic manner for describing samples of a dataset in latent space 222, and outputs a probability distribution, rather than a single output value as would a traditional autoencoder. In some examples, variational autodecoder 211 imposes a constraint on the output probability distribution, forcing it to be a normal distribution to ensure that latent space 222 is regularized. Variational autodecoder 211 maps from latent space 222 back to pixel space 221. In some examples, variational autodecoder 211 has near-compliment layers corresponding to the layers of variational autoencoder 201, but in reverse order.

FIG. 3 illustrates how compression and decompression may be tailored to different image types. A variational autoencoder performs nonlinear dimensionality reduction, or manifold learning, which projects high-dimensional data into lower-dimensional latent space. Variational autoencoders 201 and 202 are trained to approximate the high-dimensional data of images 301 and 302 with lower-dimensional data. This is how the high compression ratios are obtained.

As a result, different image types, as defined according to the most common features within an image (as opposed to file format), may produce different levels of MSE performance for a single variational autoencoder and variational autodecoder pair. Thus, some examples of architecture 100 will train different pairs of variational autoencoders and variational autodecoders on different image types. Then, when an incoming image is received for compression, selector 130 selects from among the available variational autoencoders (e.g., variational autoencoders 201 and 202 and other variational autoencoders within plurality of variational autoencoders 102).

Image 301 is an image of image type 331, such as an outdoor scene or a photograph of a person. Image 301 has a portion 361 with an identifiable feature 341 that is a face (or a rock sculpture of a face). A feature annotation 363 outlines identifiable feature 341 as a bounding polygon or bounding ellipse, as a subset of a bounding box which may be generated with common object detection processes. Feature annotation 363 has an aspect ratio represented by two orthogonal measurement indicators as aspect ratio 351 (e.g., a notional representation of a mathematical quantity). Aspect ratio 351 does not differ significantly from the value of 1, such that the height and width of identifiable feature 341 are within an order of magnitude of each other.

In contrast, image 302 is an image of image type 332, such as a map with text and lines that are thin in comparison to their length. Image 302 has a portion 362 with an identifiable feature 342 that is portion of a mapped rail line. A feature annotation 364 outlines identifiable feature 342 as a bounding box which may be generated with common object detection processes. Bounding polygons may be used for curved lines. Feature annotation 364 has an aspect ratio 352 that differs significantly from the value of 1. The height and width of identifiable feature 342 are not within an order of magnitude of each other, such that aspect ratio 352 exceeds a value of 10 (e.g., when the normalized to values of 1 or greater).

In some examples, selector 130 may use object detection and determine the aspect ratios of larger, more common features in order to classify an image into image type 331 or image type 332. Different classes and counts of image types, and different classification schemes, may be used in some examples.

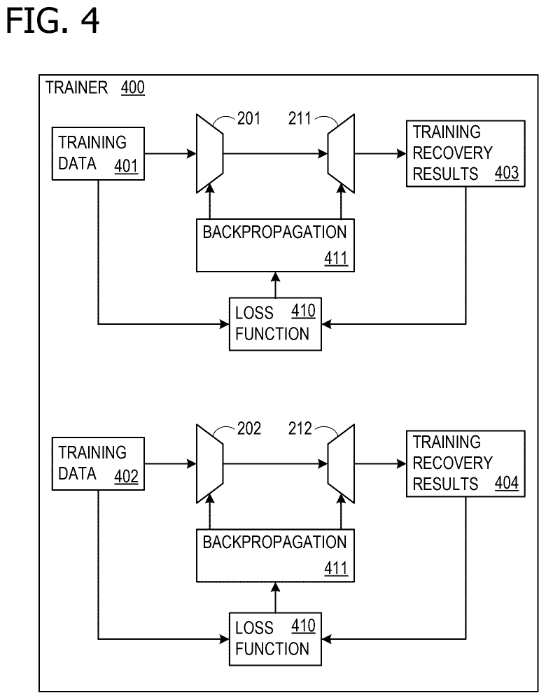

FIG. 4 illustrates further detail for training variational autoencoders 201 and 202 and variational autodecoders 211 and 212. In some examples, variational autoencoders and variational autodecoders are trained in pairs, such that variational autoencoder 201 and variational autodecoder 211 are trained as a pair and variational autoencoder 202 and variational autodecoder 212 are also trained as a different pair, as illustrated. The training for each pair (variational autoencoder 201 and variational autodecoder 211 as one pair, and variational autoencoder 202 and variational autodecoder 212 as the other pair) may be similar.

A trainer 400 has training data 401 for image type 331 and training data 402 for image type 332. Each of training data 401 and training data 402 may comprise thousands or millions of images. Some examples may not require labeling of the training data images, because a loss function 410 may be computed directly from the images within training recovery results 403 (for training data 401) or the images within training recovery results 404 (for training data 402).

A loss function 410 used for training is the example MSE calculation of Eq. (1), where the X pixels are from images within training data 401 (or training data 402) and the Y pixels are from images within training recovery results 403 (or training recovery results 404). This encourages that the input is reconstructed at the output with the least error. Backpropagation 411 is applied to both variational autoencoder 201 and variational autodecoder 211 to generate the complementary layers (e.g., in reverse order).

FIG. 5 illustrates searching for compressed images without requiring decompression to test against the search criteria. The search material is precomputed and persisted in plurality of embeddings 510 and/or plurality of captions 530. Plurality of embeddings 510 contains image embedding 511, an image embedding 512, text embedding 521, and a text embedding 522. Plurality of captions 530 contains image caption 531 and an image caption 532. Image embedding 512, text embedding 522, and image caption 532 are generated for image 302 similarly as described above for image embedding 511, text embedding 521, and image caption 531.

An association of embeddings with compressed images 515 enables identification of compressed image 311 using image embedding 511 or text embedding 521 and identification of compressed image 312 using image embedding 512 or text embedding 522. An association of captions with compressed images 535 enables identification of compressed image 311 using image caption 531 and identification of compressed image 312 using image caption 532.

A user may enter an image search query 502 as an NL description in search interface 500 to search of a desired image. Search interface 500 uses a CLIP model 120c to convert image search query 502 into a query embedding 504. CLIP model 120c may be the same model as or a different model than CLIP models 120a and 120b.

A matching function 506 compares query embedding 504 with each embedding within plurality of embeddings 510 for similarity. Some examples use a vector dot product, as shown in Eq. (2) and/or Eq. (3):

$$Similarity = query\_embedding \cdot image\_embedding \qquad Eq . ( 2 )$$

$$Similarity = query\_embedding \cdot text\_embedding \qquad Eq . ( 3 )$$

where query_embedding is query embedding 504, image_embedding is any of image embedding 511 and image embedding 512, and query_embedding is any of text embedding 521 and text embedding 522.

In some examples, matching function 506 also compares image search query 502 directly with image caption 531 and image caption 532 within plurality of captions 530. When the best match is found from any of these comparisons, or a weighted combination of these comparisons, matching function 506 alerts search interface 500, which uses association of embeddings with compressed images 515 and/or association of captions with compressed images 535 to identify compressed image 311. Search interface 500 generates request 111 to decompress compressed image 311. Alternatively, in some examples, the user may enter request 112 to decompress compressed image 312 manually, or using some other process.

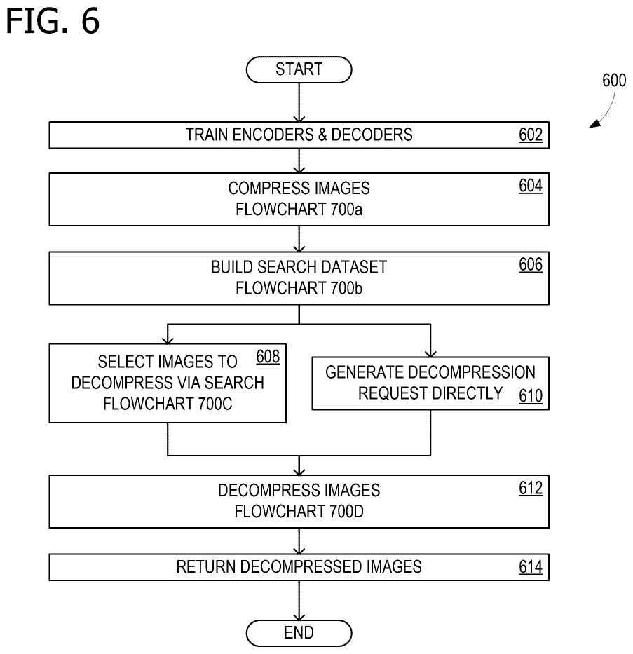

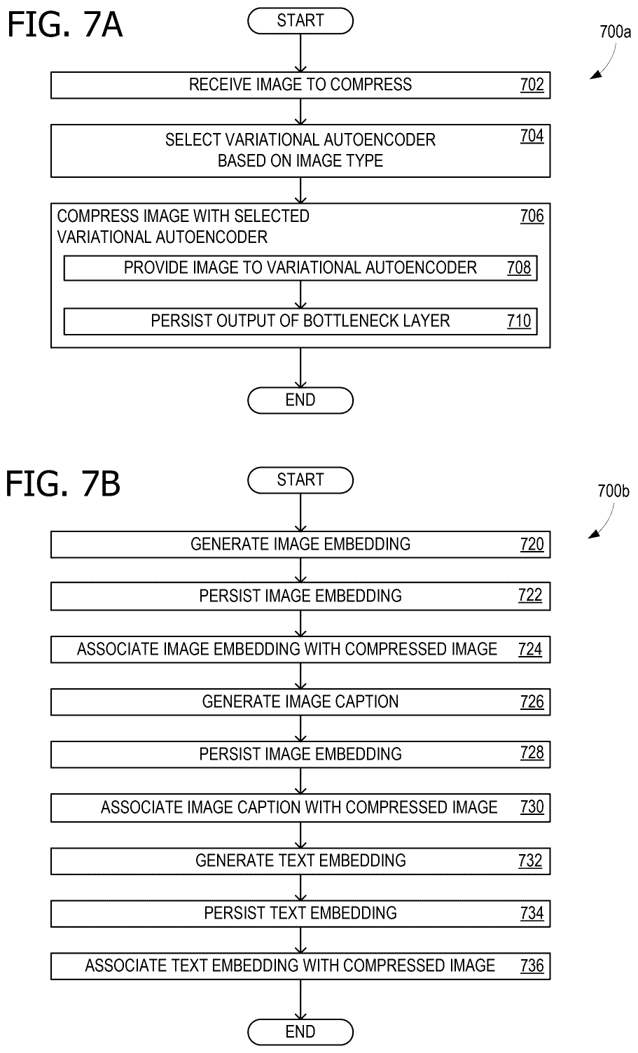

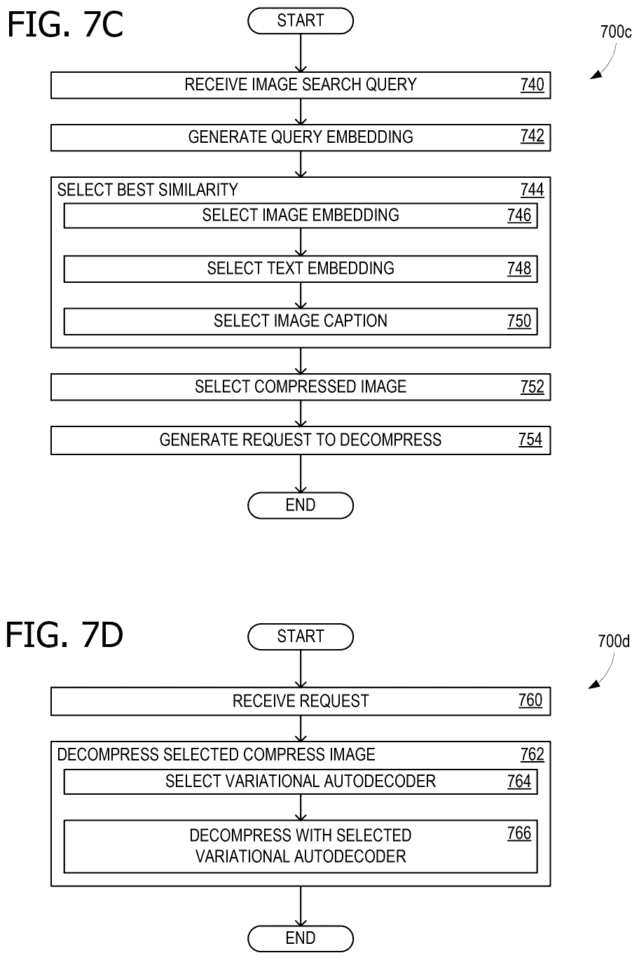

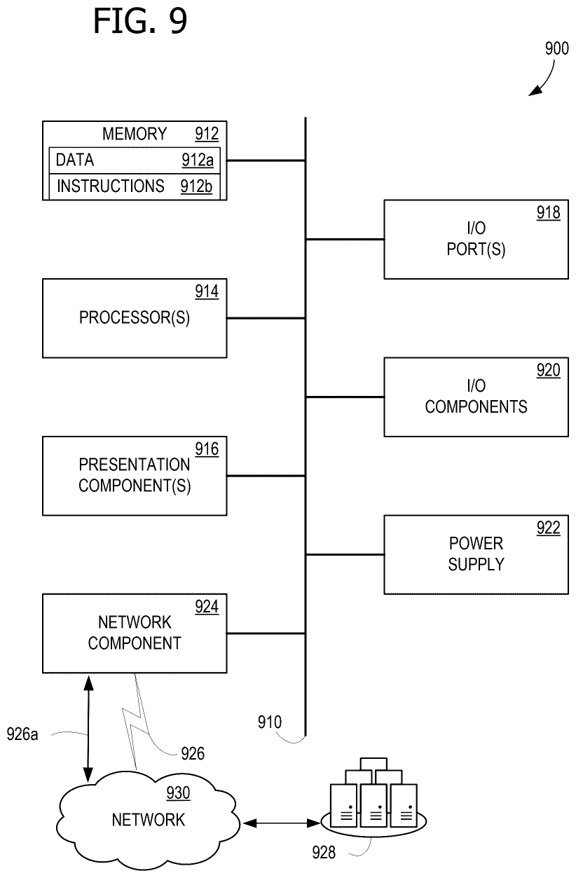

FIG. 6 shows a flowchart 600 illustrating exemplary operations that may be performed by architecture 100, and FIGS. 7A-7D are flowcharts 700a-700d showing further detail for flowchart 600. In some examples, operations described for flowcharts 600 and 700a-700d are performed by computing device 900 of FIG. 9. Flowchart 600 commences with training the variational autoencoders and variational autodecoders in pairs (as shown in FIG. 4) in operation 602.

That is operation 602 trains variational autoencoder 201 to compress images of image type 331, trains variational autodecoder 211 to decompress compressed images of image type 331, trains variational autoencoder 202 to compress images of image type 332, and trains variational autodecoder 212 to decompress compressed images of image type 332. In some examples, image type 331 and image type 332 differ by a median aspect ratio of identifiable features within each image type (e.g., image 301 type is photograph of a person or a scene, and image 302 type is a map having a set of lines with a median aspect ratio greater than 10).

Operation 604 compresses images 301 and 302 using flowchart 700a of FIG. 7A. Operation 606 builds a search dataset comprising plurality of embeddings 510 and/or plurality of captions 530 using flowchart 700b of FIG. 7B. Either operation 608 selects an image to decompress using a search process of flowchart 700c of FIG. 7C, or a decompression request (e.g., request 112 to decompress compressed image 312) is generated by another process, in operation 610. The requested image(s) are decompressed in operation 612, using flowchart 700d of FIG. 7D, and operation 614 returns the recovered images, such as recovered image 321 and/or recovered image 321.

FIG. 7A shows flowchart 700a as further detail for operation 604 of flowchart 600. Flowchart 700a is performed for both image 301 and image 302. Image 301 is received for compression in operation 702, and operation 704 selects variational autoencoder 201 from plurality of variational autoencoders 102, based on image 301 being image type 331. Operation 706 uses variational autoencoder 201 to compress image 301 into compressed image 311, and may be performed using operations 708 and 710. Operation 708 provides image 301 to variational autoencoder 201, and operation 710 persists an output of bottleneck layer 220 of variational autoencoder 201 as compressed image 311 in plurality of compressed images 104.

Image 302 is received for compression in operation 702, and operation 704 selects variational autoencoder 202 from plurality of variational autoencoders 102, based on image 302 being image type 332. Operation 706 uses variational autoencoder 202 to compress image 302 into compressed image 312, and may be performed using operations 708 and 710. Operation 708 provides image 302 to variational autoencoder 202, and operation 710 persists an output of bottleneck layer 220 of variational autoencoder 202 as compressed image 312 in plurality of compressed images 104.

FIG. 7B shows flowchart 700b as further detail for operation 606 of flowchart 600. Flowchart 700b is performed for both image 301 and image 302. Operation 720 generates image embedding 511 from image 301 using CLIP model 120a, and operation 722 persists image embedding 511 in plurality of embeddings 510. Operation 724 associates image embedding 511 with compressed image 311.

Operation 726 generates image caption 531 from image 301 using BLIP model 122, image caption 531, operation 728 persists image caption 531 in plurality of captions 530, and operation 730 associates image caption 531 with compressed image 311. Operation 732 generates text embedding 521 from image caption 531 using CLIP model 120b, operation 734 persists text embedding 521 in plurality of embeddings 510, and operation 736 associates text embedding 521 with compressed image 311.

Operation 720 generates image embedding 512 from image 302 using CLIP model 120a, and operation 722 persists image embedding 512 in plurality of embeddings 510. Operation 724 associates image embedding 512 with compressed image 312. Operation 726 generates image caption 532 from image 302 using BLIP model 122, image caption 532, operation 728 persists image caption 532 in plurality of captions 530, and operation 730 associates image caption 532 with compressed image 312. Operation 732 generates text embedding 522 from image caption 532 using CLIP model 120b, operation 734 persists text embedding 522 in plurality of embeddings 510, and operation 736 associates text embedding 522 with compressed image 312.

FIG. 7C shows flowchart 700c as further detail for operation 608 of flowchart 600. Image search query 502 is received in operation 740, and operation 742 generates query embedding 504 from image search query 502 using CLIP model 120c. Operation 744 selects the best similarity, using one or more of operations 746, 748, and 750. Operation 746 selecting text embedding 521 from among plurality of embeddings 510 by determining the similarity between image search query 502 and text embedding 521. Operation 748 selects image embedding 511 from among plurality of embeddings 510 by determining the similarity between image search query 502 and image embedding 511. Operation 750 selects image caption 531 by determining the similarity between image search query 502 and image caption 531.

Operation 752 selects compressed image 311 from among plurality of compressed images 104, based on at least selecting image embedding 511, text embedding 521, or image caption 531 as a match for image search query 502. Operation 754 generates request 111 to decompress compressed image 311, based on at least selecting compressed image 311 in operation 752.

FIG. 7D shows flowchart 700d as further detail for operation 612 of flowchart 600. Flowchart 700d is performed for both compressed image 311 and compressed image 312. Request 111 to decompress compressed image 311 is received in operation 760, and operation 762 decompress compressed image 311 using operations 764 and 766. Operation 764 selects variational autodecoder 211 from plurality of variational autodecoders 108, based on compressed image 311 being a compressed version of an image of image type 331. Operation 766 decompresses compressed image 311 into recovered image 321 using variational autodecoder 211.

Request 112 to decompress compressed image 312 is received in operation 760, and operation 762 decompress compressed image 312 using operations 764 and 766. Operation 764 selects variational autodecoder 212 from plurality of variational autodecoders 108, based on compressed image 312 being a compressed version of an image of image type 332. Operation 766 decompresses compressed image 312 into recovered image 322 using variational autodecoder 212.

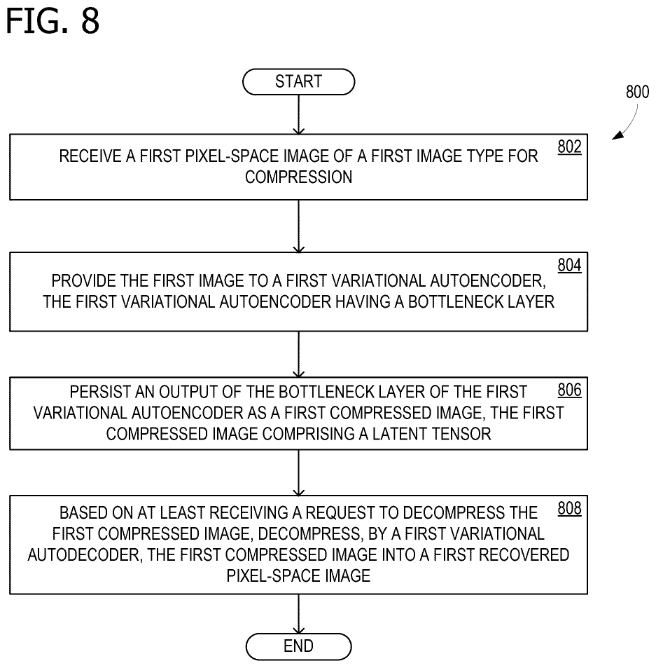

FIG. 8 shows a flowchart 800 illustrating exemplary operations that may be performed by architecture 100. In some examples, operations described for flowchart 800 are performed by computing device 900 of FIG. 9. Flowchart 800 commences with operation 802, which includes receiving a first image of a first image type for compression, the first image being in pixel space.

Operation 804 includes providing the first image to a first variational autoencoder, the first variational autoencoder having a bottleneck layer. Operation 806 includes persisting an output of the bottleneck layer of the first variational autoencoder as a first compressed image, the first compressed image comprising a latent tensor. Operation 808 includes, based on at least receiving a request to decompress the first compressed image, decompressing, by a first variational autodecoder, the first compressed image into a first recovered image, the first recovered image being in pixel space.

### Additional Examples

An example system comprises: a processor; and a computer-readable medium storing instructions that are operative upon execution by the processor to: receive a first image of a first image type for compression, the first image in pixel space; provide the first image to a first variational autoencoder, the first variational autoencoder having a bottleneck layer; persist an output of the bottleneck layer of the first variational autoencoder as a first compressed image, the first compressed image comprising a latent tensor; and based on at least receiving a request to decompress the first compressed image, decompress, by a first variational autodecoder, the first compressed image into a first recovered image, the first recovered image in pixel space.

An example computer-implemented method comprises: receiving a first image of a first image type for compression, the first image in pixel space; providing the first image to a first variational autoencoder, the first variational autoencoder having a bottleneck layer; persisting an output of the bottleneck layer of the first variational autoencoder as a first compressed image, the first compressed image comprising a latent tensor; and based on at least receiving a request to decompress the first compressed image, decompressing, by a first variational autodecoder, the first compressed image into a first recovered image, the first recovered image in pixel space.

One or more example computer storage devices have computer-executable instructions stored thereon, which, on execution by a computer, cause the computer to perform operations comprising: receiving a first image of a first image type for compression, the first image in pixel space; providing the first image to a first variational autoencoder, the first variational autoencoder having a bottleneck layer; persisting an output of the bottleneck layer of the first variational autoencoder as a first compressed image, the first compressed image comprising a latent tensor; and based on at least receiving a request to decompress the first compressed image, decompressing, by a first variational autodecoder, the first compressed image into a first recovered image, the first recovered image in pixel space.

Alternatively, or in addition to the other examples described herein, examples include any combination of the following:
selecting the first variational autoencoder from a plurality of variational autoencoders, each trained to compress images of a different image type;
the first variational autoencoder is trained to compress images of the first image type;
selecting the first variational autodecoder from a plurality of variational autodecoders, each trained to decompress compressed images of a different image type;
the first variational autodecoder is trained to decompress compressed images of the first image type;
receiving a second image of a second image type for compression, the second image in pixel space;
the second image type differs from the first image type;
selecting a second variational autoencoder from the plurality of variational autoencoders;
the second variational autoencoder is trained to compress images of the second image type;
providing the second image to the second variational autoencoder;
the second variational autoencoder has a bottleneck layer;
persisting an output of the bottleneck layer of the second variational autoencoder as a second compressed image;
the second compressed image comprises a latent tensor;
based on at least receiving a request to decompress the second compressed image, selecting a second variational autodecoder from the plurality of variational autodecoders;
the second variational autodecoder is trained to decompress compressed images of the second image type;
decompressing, by the second variational autodecoder, the second compressed image into a second recovered image;
the second recovered image is in pixel space;
training the first variational autoencoder to compress images of the first image type;
training the first variational autodecoder to decompress compressed images of the first image type;
training the second variational autoencoder to compress images of the second image type;
training the second variational autodecoder to decompress compressed images of the second image type;
generating, from the first image, using a CLIP model, a first image embedding;
persisting the first image embedding;
associating the first image embedding with the first compressed image;
receiving an image search query;
based on at least selecting the first image embedding or a first text embedding, from among a plurality of embeddings, as a match for the image search query, selecting the first compressed image from among a plurality of compressed images;
based on at least selecting the first compressed image, generating the request to decompress the first compressed image;
generating, from the first image, using a BLIP model, a first image caption;
generating, from the first image caption, using a CLIP model, a first text embedding;
persisting the first text embedding;
associating the first text embedding with the first compressed image;
selecting the first text embedding from among the plurality of embeddings comprises determining a similarity between the image search query and the first text embedding;
selecting the first image embedding from among the plurality of embeddings comprises determining a similarity between the image search query and the first image embedding;
based on at least selecting the first text embedding, from among a plurality of embeddings, as a match for the image search query, selecting the first compressed image from among a plurality of compressed images;
generating, from the image search query, using a CLIP model, a query embedding;
determining a similarity between the query embedding and each embedding of the plurality of embeddings;
selecting the first image embedding from among the plurality of embeddings comprises selecting the first image embedding based on at least the similarity between the query embedding and the first image embedding;
the first image type and the second image type differ by a median aspect ratio of identifiable features within each image type;
the first image type is photograph of a person or a scene;
the second image type is a map having a set of lines with a median aspect ratio greater than 10;
compressing, by the first variational autoencoder, the first image into the first compressed image;
compressing, by the second variational autoencoder, the second image into the second compressed image;
the same CLIP model generates the first image embedding, the first text embedding, and the query embedding;
the CLIP model that generates the first image embedding is not the CLIP model that generates the first text embedding and/or is not the CLIP model that generates the query embedding;
the BLIP model comprises a bootstrapping language-image pre-training for unified vision-language understanding and generation model; and
the plurality of embeddings includes the first image embedding, the first text embedding, a second image embedding for the second image, and a second text embedding for the second image.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 9 is a block diagram of an example computing device 900 (e.g., a computer storage device) for implementing aspects disclosed herein, and is designated generally as computing device 900. In some examples, one or more computing devices 900 are provided for an on-premises computing solution. In some examples, one or more computing devices 900 are provided as a cloud computing solution. In some examples, a combination of on-premises and cloud computing solutions are used. Computing device 900 is but one example of a suitable computing environment and is not intended to suggest any limitation as to the scope of use or functionality of the examples disclosed herein, whether used singly or as part of a larger set.

Neither should computing device 900 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 900 includes a bus 910 that directly or indirectly couples the following devices: computer storage memory 912, one or more processors 914, one or more presentation components 916, input/output (I/O) ports 918, I/O components 920, a power supply 922, and a network component 924. While computing device 900 is depicted as a seemingly single device, multiple computing devices 900 may work together and share the depicted device resources. For example, memory 912 may be distributed across multiple devices, and processor(s) 914 may be housed with different devices.

Bus 910 represents what may be one or more buses (such as an address bus, data bus, or a combination thereof). Although the various blocks of FIG. 9 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 9 and the references herein to a “computing device.” Memory 912 may take the form of the computer storage media referenced below and operatively provide storage of computer-readable instructions, data structures, program modules and other data for the computing device 900. In some examples, memory 912 stores one or more of an operating system, a universal application platform, or other program modules and program data. Memory 912 is thus able to store and access data 912a and instructions 912b that are executable by processor 914 and configured to carry out the various operations disclosed herein. Thus, computing device 900 comprises a computer storage device having computer-executable instructions 912b stored thereon.

In some examples, memory 912 includes computer storage media. Memory 912 may include any quantity of memory associated with or accessible by the computing device 900. Memory 912 may be internal to the computing device 900 (as shown in FIG. 9), external to the computing device 900 (not shown), or both (not shown). Additionally, or alternatively, the memory 912 may be distributed across multiple computing devices 900, for example, in a virtualized environment in which instruction processing is carried out on multiple computing devices 900. For the purposes of this disclosure, “computer storage media,” “computer storage memory,” “memory,” and “memory devices” are synonymous terms for the memory 912, and none of these terms include carrier waves or propagating signaling.

Processor(s) 914 may include any quantity of processing units that read data from various entities, such as memory 912 or I/O components 920. Specifically, processor(s) 914 are programmed to execute computer-executable instructions for implementing aspects of the disclosure. The instructions may be performed by the processor, by multiple processors within the computing device 900, or by a processor external to the client computing device 900. In some examples, the processor(s) 914 are programmed to execute instructions such as those illustrated in the flow charts discussed below and depicted in the accompanying drawings. Moreover, in some examples, the processor(s) 914 represents an implementation of analog techniques to perform the operations described herein. For example, the operations may be performed by an analog client computing device 900 and/or a digital client computing device 900. Presentation component(s) 916 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 900, across a wired connection, or in other ways. I/O ports 918 allow computing device 900 to be logically coupled to other devices including I/O components 920, some of which may be built in. Example I/O components 920 include, for example but without limitation, a microphone, joystick, game pad, satellite dish, scanner, printer, wireless device, etc.

Computing device 900 may operate in a networked environment via the network component 924 using logical connections to one or more remote computers. In some examples, the network component 924 includes a network interface card and/or computer-executable instructions (e.g., a driver) for operating the network interface card. Communication between the computing device 900 and other devices may occur using any protocol or mechanism over any wired or wireless connection. In some examples, network component 924 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 924 communicates over wireless communication link 926 and/or a wired communication link 926a to a remote resource 928 (e.g., a cloud resource) across network 930. Various different examples of communication links 926 and 926a include a wireless connection, a wired connection, and/or a dedicated link, and in some examples, at least a portion is routed through the internet.

Although described in connection with an example computing device 900, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure do not include signals. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
receive a first image of a first image type for compression, the first image being in pixel space;
provide the first image to a first variational autoencoder, the first variational autoencoder having a bottleneck layer;
persist an output of the bottleneck layer of the first variational autoencoder as a first compressed image, the first compressed image comprising a latent tensor; and
based on at least receiving a request to decompress the first compressed image, decompress, by a first variational autodecoder, the first compressed image into a first recovered image, the first recovered image being in pixel space.

2. The system of claim 1, wherein the instructions are further operative to:
select the first variational autoencoder from a plurality of variational autoencoders, each of the plurality of variational autoencoders trained to compress images of a different image type, wherein the first variational autoencoder is trained to compress images of the first image type;
select the first variational autodecoder from a plurality of variational autodecoders, each of the plurality of variational autodecoders trained to decompress compressed images of a different image type, wherein the first variational autodecoder is trained to decompress compressed images of the first image type;
receive a second image of a second image type for compression, the second image being in pixel space, wherein the second image type differs from the first image type;
select a second variational autoencoder from the plurality of variational autoencoders, the second variational autoencoder trained to compress images of the second image type;
provide the second image to the second variational autoencoder, the second variational autoencoder having a bottleneck layer;
persist an output of the bottleneck layer of the second variational autoencoder as a second compressed image, the second compressed image comprising a latent tensor; and
based on at least receiving a request to decompress the second compressed image:
select a second variational autodecoder from the plurality of variational autodecoders, the second variational autodecoder trained to decompress compressed images of the second image type; and
decompress, by the second variational autodecoder, the second compressed image into a second recovered image, the second recovered image being in pixel space.

3. The system of claim 2, wherein the instructions are further operative to:
train the first variational autoencoder to compress images of the first image type;
train the first variational autodecoder to decompress compressed images of the first image type;
train the second variational autoencoder to compress images of the second image type; and
train the second variational autodecoder to decompress compressed images of the second image type.

4. The system of claim 1, wherein the instructions are further operative to:
generate, from the first image, using a contrastive language-image pre-training (CLIP) model, a first image embedding;
persist the first image embedding;
associate the first image embedding with the first compressed image;
receive an image search query;
based on at least selecting the first image embedding or a first text embedding, from among a plurality of embeddings, as a match for the image search query, select the first compressed image from among a plurality of compressed images; and
based on at least selecting the first compressed image, generate the request to decompress the first compressed image.

5. The system of claim 4, wherein the instructions are further operative to:
generate, from the first image, using a bootstrapping language-image pre-training (BLIP) model, a first image caption;
generate, from the first image caption, using a CLIP model, a first text embedding;
persist the first text embedding; and
associate the first text embedding with the first compressed image,
wherein selecting the first text embedding from among the plurality of embeddings comprises determining a similarity between the image search query and the first text embedding.

6. The system of claim 4, wherein the instructions are further operative to:
generate, from the image search query, using a CLIP model, a query embedding; and
determine a similarity between the query embedding and each embedding of the plurality of embeddings,
wherein selecting the first image embedding from among the plurality of embeddings comprises selecting the first image embedding based on at least the similarity between the query embedding and the first image embedding.

7. The system of claim 1, wherein the instructions are further operative to:
generate, from the first image, using a bootstrapping language-image pre-training (BLIP) model, a first image caption;
generate, from the first image caption, using a contrastive language-image pre-training (CLIP) model, a first text embedding;
persist the first text embedding;
associate the first text embedding with the first compressed image;
receive an image search query;
based on at least selecting the first text embedding, from among a plurality of embeddings, as a match for the image search query, select the first compressed image from among a plurality of compressed images; and
based on at least selecting the first compressed image, generate the request to decompress the first compressed image.

8. A computer-implemented method comprising:
receiving a first image of a first image type for compression, the first image being in pixel space;
providing the first image to a first variational autoencoder, the first variational autoencoder having a bottleneck layer;
persisting an output of the bottleneck layer of the first variational autoencoder as a first compressed image, the first compressed image comprising a latent tensor; and
based on at least receiving a request to decompress the first compressed image, decompressing, by a first variational autodecoder, the first compressed image into a first recovered image, the first recovered image being in pixel space.

9. The computer-implemented method of claim 8, further comprising:
selecting the first variational autoencoder from a plurality of variational autoencoders, each of the plurality of variational autoencoders trained to compress images of a different image type, wherein the first variational autoencoder is trained to compress images of the first image type;
selecting the first variational autodecoder from a plurality of variational autodecoders, each of the plurality of variational autodecoders trained to decompress compressed images of a different image type, wherein the first variational autodecoder is trained to decompress compressed images of the first image type;
receiving a second image of a second image type for compression, the second image being in pixel space, wherein the second image type differs from the first image type;
selecting a second variational autoencoder from the plurality of variational autoencoders, wherein the second variational autoencoder is trained to compress images of the second image type;
providing the second image to the second variational autoencoder, the second variational autoencoder having a bottleneck layer;
persisting an output of the bottleneck layer of the second variational autoencoder as a second compressed image, the second compressed image comprising a latent tensor; and
based on at least receiving a request to decompress the second compressed image:
selecting a second variational autodecoder from the plurality of variational autodecoders, wherein the second variational autodecoder is trained to decompress compressed images of the second image type; and
decompressing, by the second variational autodecoder, the second compressed image into a second recovered image, the second recovered image being in pixel space.

10. The computer-implemented method of claim 9, further comprising:
training the first variational autoencoder to compress images of the first image type;
training the first variational autodecoder to decompress compressed images of the first image type;
training the second variational autoencoder to compress images of the second image type; and
training the second variational autodecoder to decompress compressed images of the second image type.

11. The computer-implemented method of claim 8, further comprising:
generating, from the first image, using a contrastive language-image pre-training (CLIP) model, a first image embedding;
persisting the first image embedding;
associating the first image embedding with the first compressed image;
receiving an image search query;
based on at least selecting the first image embedding or a first text embedding, from among a plurality of embeddings, as a match for the image search query, selecting the first compressed image from among a plurality of compressed images; and
based on at least selecting the first compressed image, generating the request to decompress the first compressed image.

12. The computer-implemented method of claim 11, further comprising:
generating, from the first image, using a bootstrapping language-image pre-training (BLIP) model, a first image caption;
generating, from the first image caption, using a CLIP model, a first text embedding;
persisting the first text embedding;
associating the first text embedding with the first compressed image; and
wherein selecting the first text embedding from among the plurality of embeddings comprises determining a similarity between the image search query and the first text embedding.

13. The computer-implemented method of claim 11, further comprising:
generating, from the image search query, using a CLIP model, a query embedding;
determining a similarity between the query embedding and each embedding of the plurality of embeddings; and
wherein selecting the first image embedding from among the plurality of embeddings comprises selecting the first image embedding based on at least the similarity between the query embedding and the first image embedding.

14. The computer-implemented method of claim 8, further comprising:
generating, from the first image, using a bootstrapping language-image pre-training (BLIP) model, a first image caption;
generating, from the first image caption, using a contrastive language-image pre-training (CLIP) model, a first text embedding;
persisting the first text embedding;
associating the first text embedding with the first compressed image;
receiving an image search query;
based on at least selecting the first text embedding, from among a plurality of embeddings, as a match for the image search query, selecting the first compressed image from among a plurality of compressed images; and
based on at least selecting the first compressed image, generating the request to decompress the first compressed image.

15. A computer storage device having computer-executable instructions stored thereon, which, on execution by a computer, cause the computer to perform operations comprising:
receiving a first image of a first image type for compression, the first image being in pixel space;
providing the first image to a first variational autoencoder, the first variational autoencoder having a bottleneck layer;
persisting an output of the bottleneck layer of the first variational autoencoder as a first compressed image, the first compressed image comprising a latent tensor; and
based on at least receiving a request to decompress the first compressed image, decompressing, by a first variational autodecoder, the first compressed image into a first recovered image, the first recovered image being in pixel space.

16. The computer storage device of claim 15, wherein the operations further comprise:
selecting the first variational autoencoder from a plurality of variational autoencoders, each of the plurality of variational autoencoders trained to compress images of a different image type, wherein the first variational autoencoder is trained to compress images of the first image type;
selecting the first variational autodecoder from a plurality of variational autodecoders, each of the plurality of variational autodecoders trained to decompress compressed images of a different image type, wherein the first variational autodecoder is trained to decompress compressed images of the first image type;
receiving a second image of a second image type for compression, the second image in pixel space, wherein the second image type differs from the first image type;
selecting a second variational autoencoder from the plurality of variational autoencoders, wherein the second variational autoencoder is trained to compress images of the second image type;
providing the second image to the second variational autoencoder, the second variational autoencoder having a bottleneck layer;
persisting an output of the bottleneck layer of the second variational autoencoder as a second compressed image, the second compressed image comprising a latent tensor; and
based on at least receiving a request to decompress the second compressed image:
selecting a second variational autodecoder from the plurality of variational autodecoders, the second variational autodecoder trained to decompress compressed images of the second image type; and
decompressing, by the second variational autodecoder, the second compressed image into a second recovered image, the second recovered image being in pixel space.

17. The computer storage device of claim 15, wherein the operations further comprise:
generating, from the first image, using a contrastive language-image pre-training (CLIP) model, a first image embedding;
persisting the first image embedding;
associating the first image embedding with the first compressed image;
receiving an image search query;
based on at least selecting the first image embedding or a first text embedding, from among a plurality of embeddings, as a match for the image search query, selecting the first compressed image from among a plurality of compressed images; and
based on at least selecting the first compressed image, generating the request to decompress the first compressed image.

18. The computer storage device of claim 17, wherein the operations further comprise:
generating, from the first image, using a bootstrapping language-image pre-training (BLIP) model, a first image caption;
generating, from the first image caption, using a CLIP model, a first text embedding;
persisting the first text embedding;
associating the first text embedding with the first compressed image; and
wherein selecting the first text embedding from among the plurality of embeddings comprises determining a similarity between the image search query and the first text embedding.

19. The computer storage device of claim 17, wherein the operations further comprise:
generating, from the image search query, using a CLIP model, a query embedding;
determining a similarity between the query embedding and each embedding of the plurality of embeddings; and
wherein selecting the first image embedding from among the plurality of embeddings comprises selecting the first image embedding based on at least the similarity between the query embedding and the first image embedding.

20. The computer storage device of claim 15, wherein the operations further comprise:
generating, from the first image, using a bootstrapping language-image pre-training (BLIP) model, a first image caption;
generating, from the first image caption, using a contrastive language-image pre-training (CLIP) model, a first text embedding;
persisting the first text embedding;
associating the first text embedding with the first compressed image;
receiving an image search query;
based on at least selecting the first text embedding, from among a plurality of embeddings, as a match for the image search query, selecting the first compressed image from among a plurality of compressed images; and
based on at least selecting the first compressed image, generating the request to decompress the first compressed image.
